(19) United States
(12) Patent Application Publication
(10) Pub. No.: US 2020/0398989 A1
(43) Pub. Date: Dec. 24, 2020

(54) LATCH ASSEMBLY FOR CABIN ATTENDANT SEAT

(71) Applicant: AMI Industries, Inc., Colorado Springs, CO (US)

(72) Inventor: Kyler Marutzky, Colorado Springs, CO (US)

(73) Assignee: AMI Industries, Inc., Colorado Springs, CO (US)

(21) Appl. No.: 16/459,964

(22) Filed: Jul. 2, 2019

Related U.S. Application Data
(60) Provisional application No. 62/864,838, filed on Jun. 21, 2019.

(51) Int. Cl. B64D 11/06

(52) U.S. Cl. CPC B64D 11/0691; B64D 11/0627

(57) ABSTRACT

A latch assembly for a door of a cabin attendant seat storage compartment may comprise a release handle configured to rotate relative to the door. A cable may be coupled to the release handle. A latch pin may be coupled to the cable. The latch pin may be configured to translate in a direction parallel to an axis of rotation of the release handle.

### CROSS REFERENCE TO RELATED APPLICATIONS

This application claims priority to, and the benefit of, U.S. Provisional Application Ser. No. 62/864,838, titled “LATCH ASSEMBLY FOR CABIN ATTENDANT SEAT,” filed Jun. 21, 2019, which is incorporated herein by reference in its entirety for all purposes.

### FIELD

The present disclosure relates to aircraft seats and, more specifically, to a latch assembly for a cabin attendant seat.

### BACKGROUND

Aircraft cabin attendant seats are used for flight attendant safety and comfort during taxi, takeoff, landing, and inflight rest periods. Useable storage space in an aircraft cabin may be limited, and areas within the flight attendant seats may be used for storage. For example, life vests, personal breathing apparatus (“PBE”), or other emergency equipment may be housed within a compartment located near the bottom of the attendant seat. A securement mechanism may be employed to prevent a door to the compartment from opening unintentionally during flight. However, space within the attendant seat for translation and/or rotation of the securement mechanism tends to be limited.

### SUMMARY

A latch assembly for a door of a cabin attendant seat storage compartment is disclosed herein. In accordance with various embodiments, the latch assembly may comprise a release handle configured to rotate relative to the door, a cable coupled to the release handle, and a first latch pin coupled to the cable. The first latch pin may be configured to translate in a direction parallel to an axis of rotation of the release handle.

In various embodiments, a second latch pin may be coupled to the cable. In various embodiments, a cable retainer may be coupled to the release handle and configured to engage the cable.

In various embodiments, a first biasing member may be operationally coupled to the first latch pin, and a second biasing member may be operationally coupled to the second latch pin.

In various embodiments, the first latch pin may comprise a head portion and a shaft portion. In various embodiments, the head portion may comprise a sloped surface. In various embodiments, the cable may be attached to the shaft portion of the first latch pin via a ball-and-socket joint.

A cabin attendant seat is also disclosed herein. In accordance with various embodiments, the cabin attendant seat may comprise a housing, a door rotationally coupled to the housing, and a release handle configured to rotate relative to the door. A cable may be coupled to the release handle. A first latch pin may be coupled to the cable. The first latch pin may be configured to translate in a first direction parallel to an axis of rotation of the release handle.

In various embodiments, a first wall of the housing may define a first orifice configured to receive the first latch pin. In various embodiments, a second latch pin may be coupled to the cable. A second wall of the housing may define a second orifice configured to receive the second latch pin.

In various embodiments, a first biasing member may be operationally coupled to the first latch pin, and a second biasing may be member operationally coupled to the second latch pin. In various embodiments, the first biasing member may be configured to bias the first latch pin toward the first wall of the housing, and the second biasing member may be configured to bias the second latch pin toward the second wall of the housing.

In various embodiments, a cable retainer may be coupled to the release handle and configured to engage the cable. In various embodiments, the first latch pin may comprise a head portion and a shaft portion. In various embodiments, the head portion may comprise a sloped surface. The sloped surface may be oriented away from an exterior wall of the door.

In various embodiments, the cable may be attached to the shaft portion of the first latch pin via a ball-and-socket joint. In various embodiments, the first latch pin may comprise a protrusion located in a channel defined by the door.

A method of assembling a latch assembly for securing a door for a storage compartment of a cabin attendant seat is also disclosed herein. In accordance with various embodiments, the method may comprise locating a first latch pin through a first sidewall of the door, locating a second latch pin through a second sidewall of the door opposite the first sidewall, coupling a cable to the first latch pin and the second latch pin, and coupling the cable to a release handle such that rotation of the cable imparts tension in the cable and translates the first latch pin and the second latch pin linearly along a plane parallel to an axis of rotation of the release handle.

In various embodiments, the method may further comprise biasing the first latch pin in a first direction, and biasing the second latch pin a second direction opposite the first direction.

In various embodiments, the method may further comprise locating a protrusion extending from the first latch pin in a channel defined by the door.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be exemplary in nature and non-limiting.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the figures, wherein like numerals denote like elements.

FIG. 1 illustrates a cabin attendant seat having a storage compartment door in a closed position, in a secured position and an unsecured position, respectively, in accordance with various embodiments;

FIG. 2 illustrates a storage compartment door, of an attendant seat, in an open, in accordance with various embodiments;

FIG. 3 illustrates a latch assembly of a storage compartment door, in accordance with various embodiments;

FIGS. 4A and 4B illustrate translation of a latch assembly to an unlocked position, in accordance with various embodiments;

FIGS. 5A and 5B illustrate a pin of a latch assembly, in accordance with various embodiments;

FIGS. 6A, 6B, and 6C illustrate translation of a latch assembly to a locked position, in accordance with various embodiments;

FIGS. 7A and 7B illustrate a cable receptacle on a latch assembly release handle, in accordance with various embodiments; and

FIG. 8 illustrates a method of assembling a latch assembly for securing a door for a cabin attendant seat compartment, in accordance with various embodiments.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the exemplary embodiments of the disclosure, it should be understood that other embodiments may be realized and that logical changes and adaptations in design and construction may be made in accordance with this disclosure and the teachings herein. Thus, the detailed description herein is presented for purposes of illustration only and not limitation. The steps recited in any of the method or process descriptions may be executed in any order and are not necessarily limited to the order presented.

Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to “without contact” (or similar phrases) may also include reduced contact or minimal contact. Surface shading lines may be used throughout the figures to denote different parts but not necessarily to denote the same or different materials.

Surface shading and/or crosshatching lines may be used throughout the figures to denote different parts, but not necessarily to denote the same or different materials. Throughout the present disclosure, like reference numbers denote like elements. Accordingly, elements with like element numbering may be shown in the figures, but may not necessarily be repeated herein for the sake of clarity.

A latch assembly for securing the door of a cabin attend seat compartment is disclosed herein. In various embodiments, the latch assembly may include a pair of latch pins operationally coupled, via a cable, to a release handle that pivots relative to the door. Upon rotation of the release handle, the cable may translate the latch pins into the door, thereby allowing the door to pivot to an open position. The latch pins may translate linearly in a direction parallel to an axis of rotation of the release handle. Configuring the latch pins to translate linearly, as opposed to rotationally about an axis of rotation, tends to reduce the envelope or space associated with the latch assembly.

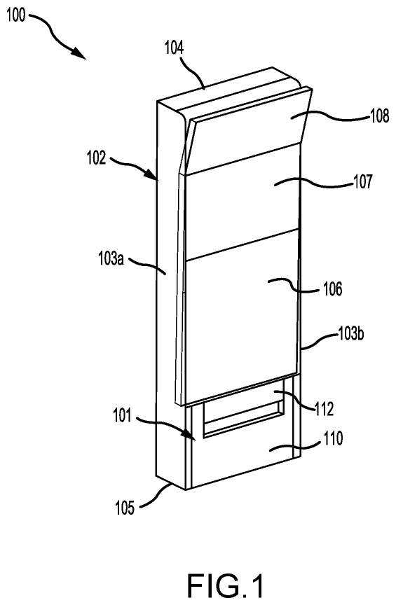

With reference to FIG. 1, a cabin attendant seat 100 is illustrated, in accordance with various embodiments. Seat 100 includes a housing 102. Housing 102 includes opposing first and second walls 103a, 103b. First and second walls 103a, 103b each extend from a head end 104 of housing 102 to a foot end 105 of housing 102. Seat 100 includes a seat pan 106, a backrest 107, and a headrest 108. Headrest 108 may be located proximate head end 104 of housing 102. Backrest 107 may be located generally between seat pan 106 and headrest 108. Seat pan 106 may be configured to rotate relative to housing 102. In various embodiments, seat pan 106 may rotate toward and away from backrest 107. Seat pan 106, backrest 107, and/or headrest 108 may be partially stored within housing 102 of seat 100. Housing 102 may provide structural support for seat 100. In this regard, housing 102 may be secured to an aircraft structure, such as a floor or a wall of an aircraft.

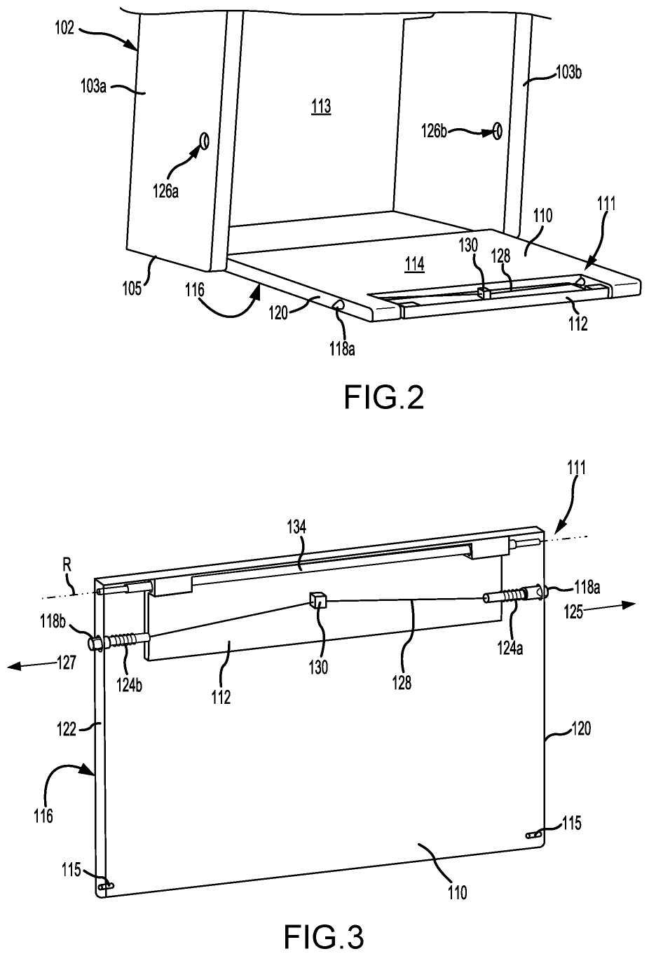

In accordance with various embodiments, seat 100 includes a lower storage compartment 101. Lower storage compartment 101 may be located proximate foot end 105 of housing 102. A housing door 110 may be located over lower storage compartment 101. Door 110 may be pivotably coupled to first and second walls 103a, 103b of housing 102. A release handle 112 may be disposed in door 110. Release handle 112 may be configured to release a latch assembly 111, with momentary reference to FIG. 2, of door 110, thereby allowing door 110 to pivot away from housing 102.

FIG. 2 illustrates door 110 in an open position, in accordance with various embodiments. Opening door 110 exposes a volume 113 within housing 102. In various embodiments, door 110 is pivotably coupled to housing 102 via hinge joints 115, with momentary reference to FIG. 3. Hinge joints 115 may be located proximate foot end 105 of housing 102. Door 110 includes an interior (or first) wall 114 and an exterior (or second) wall 116. When door 110 is in the closed position, as shown in FIG. 1, interior wall 114 is oriented toward volume 113 (i.e., toward an interior of housing 102) and exterior wall 116 is oriented away from volume 113 (i.e., away from an interior of housing 102). In accordance with various embodiments, seat 100 includes a latch assembly 111 configured to secure door 110 to housing 102.

Referring to FIG. 3, further details of latch assembly 111 are illustrated, in accordance with various embodiments. In FIG. 3, interior wall 114 of door 110 has been removed to illustrate features of latch assembly 111. Latch assembly 111 is located generally opposite hinge joints 115. Latch assembly 111 includes a first latch pin 118a and a second latch pin 118b. First latch pin 118a is located through a first sidewall 120 of door 110. Second latch pin 118b is located through a second sidewall 122 of door 110. Second sidewall 122 is opposite first sidewall 120. With brief reference to FIG. 2, in various embodiments, first and second sidewalls 120, 122 extend between interior wall 114 and exterior wall 116 of door 110. In various embodiments, first and second latch pins 118a, 118b may be located in the volume between (i.e., defined by) interior wall 114 and exterior wall 116 of door 110.

Returning to FIG. 3, a first biasing member 124a may be operationally coupled to first latch pin 118a. A second biasing member 124b may be operationally coupled to second latch pin 118b. With combined reference to FIG. 2 and FIG. 3, first biasing member 124a is configured to bias first latch pin 118a toward first wall 103a of housing 102 and away from release handle 112 (i.e., in the direction of arrow 125). First wall 103a of housing 102 defines a first orifice 126a configured to receive first latch pin 118a. Second biasing member 124b is configured to bias second latch pin 118b toward second wall 103b of housing 102 and away from release handle 112 (i.e., in the direction of arrow 127). Second wall 103b of housing 102 defines a second orifice 126b configured to receive second latch pin 118b.

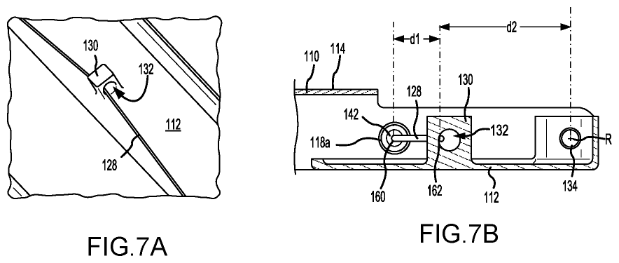

Latch assembly 111 further includes a cable 128. Cable 128 is attached to first and second latch pins 118a, 118b. Cable 128 is also coupled to release handle 112 such that rotation of release handle 112 imparts tension on cable 128. In various embodiments, release handle 112 includes a cable retainer 130. Cable retainer 130 is configured to engage and retain cable 128 such that cable 128 translates with release handle 112. In various embodiments, cable retainer 130 may define a circular orifice 132, with momentary reference to FIG. 7A, through which cable 128 is located.

Release handle 112 is pivotably coupled to door 110. In various embodiments, latch assembly 111 may include a shaft 134 about which release handle 112 rotates. Shaft 134 may be coupled to door 110. In various embodiments, latch assembly 111 may include one or more torsion spring(s) configured to bias release handle 112 circumferentially about shaft 134 and toward door 110. In various embodiments, the force generated by first and second biasing members 124a and 124b biases release handle 112 circumferentially about shaft 134 and toward door 110.

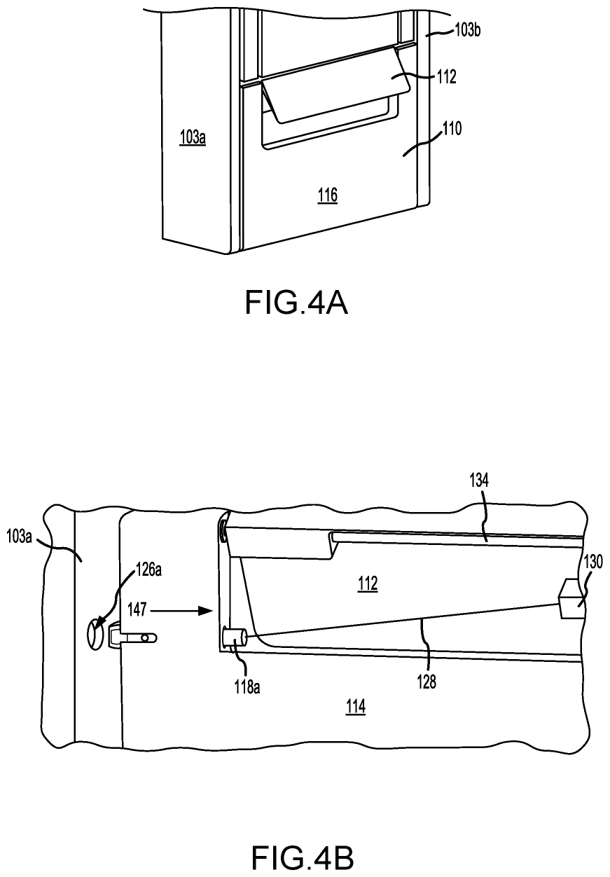

With reference to FIGS. 4A and 4B, release handle 112 and latch assembly 111 are illustrated in a released, or unsecured, position. In accordance with various embodiments, rotation of release handle 112 about shaft 134 translates cable 128 away from door 110. The translation of cable 128 translates or “pulls” first and second latch pins 118a, 118b away from first and second walls 103a, 103b, respectively. Latch assembly 111 is configured such that first and second latch pins 118a, 118b translate linearly, in a direction parallel to the axis of rotation R of release handle 112, and/or along a plane parallel to axis of rotation R of release handle 112, with momentary reference to FIG. 3. In this regard, first and second latch pins 118a, 118b move linearly, as opposed circumferentially about their own axis of rotation, within the envelope defined by interior wall 114 and exterior wall 116 of door 110. Configuring first and second latch pins 118a, 118b to move linearly tends to reduce the envelope or space needed within door 110 to accommodate first and second latch pins 118a, 118b.

Upon release handle 112 rotating a predetermined number of degrees (e.g., 45°, 90°, etc.), first latch pin 118a translates out first orifice 126a and second latch pin 118b translates out second orifice 126b. Once first and second latch pins 118a, 118b are located completely outside first and second orifices 126a, 126b (i.e., once there is no longer contact or interference between first and second latch pins 118a, 118b and first and second walls 103a, 103b of housing 102), door 110 may begin to open (i.e., pivot away from housing 102).

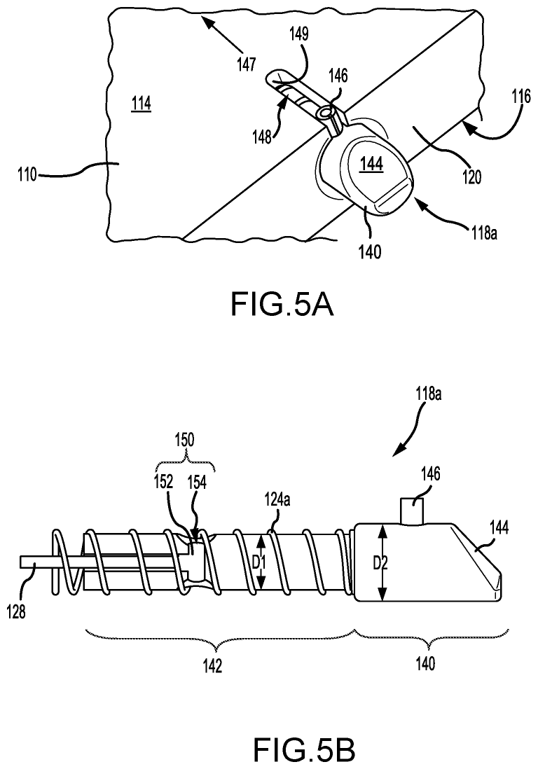

With reference to FIGS. 5A and 5B, additional details of first latch pin 118a are illustrated. While FIGS. 5A and 5B illustrate first latch pin 118a, it is contemplated and understood that second latch pin 118b may include the features and functionalities as described herein with reference to first latch pin 118a.

In accordance with various embodiments, first latch pin 118a may include a head portion 140 and a shaft portion 142. A width or diameter D1 of shaft portion 142 may be less than a width or diameter D2 of head portion 140. In various embodiments, first biasing member 124a may be located around shaft portion 142.

In various embodiments, head portion 140 includes a sloped surface 144. In various embodiments, sloped surface 144 is oriented toward interior wall 114 and away from exterior wall 116 of door 110. In this regard, sloped surface 144 may contact first wall 103a of housing 102 as door 110 translates from the open position (FIG. 2) to the closed position (FIG. 1). In other words, sloped surface 144 may contact first wall 103a as latch assembly 111 translates from the unsecured position (FIG. 2) to the secured position (FIG. 1).

In various embodiments, first latch pin 118a includes a protrusion 146. Protrusion 146 extends radially outward from first latch pin 118a. In various embodiments, protrusion 146 may extend radially from head portion 140. Protrusion 146 is located within a channel 148 defined by door 110. Channel 148 may be defined by interior wall 114 and first sidewall 120 of door 110. Protrusion 146 is configured to limit translation of first latch pin 118a into door 110 (i.e., in the direction of arrow 147). The interference generated between protrusion 146 and surface 149 of channel 148 limits translation of first latch pin 118a, thereby blocking further rotation of release handle 112 about shaft 134, with momentary reference to FIG. 4B.

In various embodiments, cable 128 is coupled to first latch pin 118a via a ball-and-socket joint 150. Ball-and-socket joint 150 may comprise a spherically-shaped end 152 of cable 128 located within a socket 154 (i.e., an orifice) defined by shaft portion 142 of first latch pin 118a. Ball-and-socket joint 150 may allow multidirectional movement and rotation of cable 128 relative to first latch pin 118a.

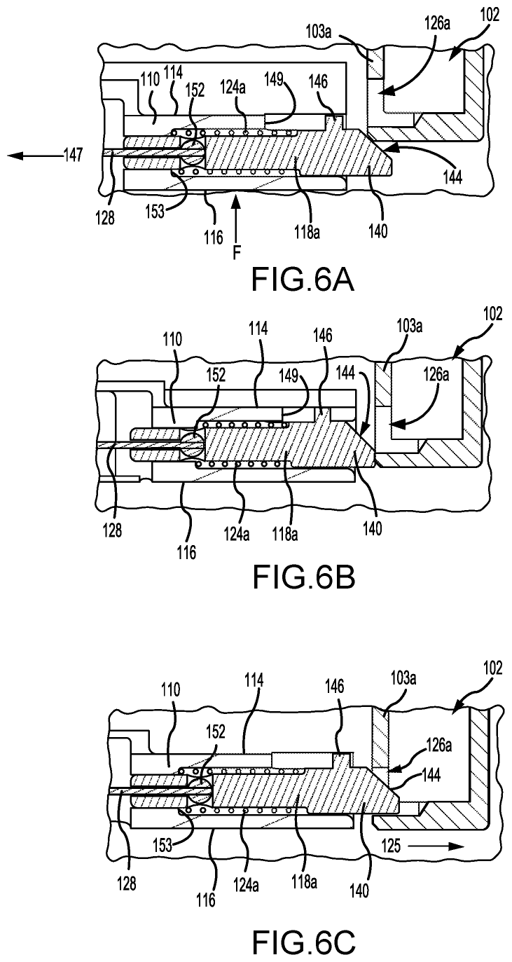

With reference to FIGS. 6A, 6B, and 6C, a cross-section views of translation of first latch pin 118a between an unsecured position and a secured position are illustrated. FIG. 6A illustrates first latch pin 118a in an unsecured position. FIG. 6C illustrates first latch pin 118a in a secured position. FIG. 6B illustrates a positioning of first latch pin 118a between the unsecured positioned of FIG. 6A and the secured position of FIG. 6C. While FIGS. 6A, 6B, and 6C illustrate first latch pin 118a, it is contemplated and understood that second latch pin 118b may include the features and functionalities as described herein with reference to first latch pin 118a.

In various embodiments, when securing door 110, a force F may be applied against exterior wall 116 to push (i.e., translate) door 110 towards housing 102. The force F may cause sloped surface 144 of first latch pin 118a to contact and translate along first wall 103a. Sloped surface 144 translating across first wall 103a forces first latch pin 118a into door 110 (i.e., in the direction of arrow 147). Sloped surface 144 may reduce friction between first wall 103a and first latch pin 118a and/or facilitate translation of first latch pin 118a into door 110 (i.e., in the direction of arrow 147). Sloped surface 144 may allow first latch pin 118a to slide more easily over the surface of first wall 103a, thereby facilitating the translation of first latch pin 118a into the volume between interior wall 114 and exterior wall 116 of door 110 when closing door 110.

First latch pin 118a remains in door 110 until head portion 140 clears first wall 103a. In other words, once head portion 140 is aligned with first orifice 126a, the force exerted by first biasing member 124a on first latch pin 118a causes head portion 140 to translate into first orifice 126a (i.e., in the direction of arrow 125). Locating first latch pin 118a within first orifice 126a secures door 110 to housing 102. In this regard, an interference generated between first latch pin 118a and the surfaces of first orifice 126a blocks door 110 from pivoting relative to housing 102.

First biasing member 124a may comprise a coil spring, Belville spring, leaf spring, or any other suitable biasing device. First biasing member 124a is located between head portion 140 and an interference surface 153 of door 110.

With reference to FIGS. 7A and 7B, and continued reference to FIGS. 2 and 3, details of cable retainer 130 are illustrated. In accordance with various embodiments, a location of cable retainer 130 may be selected based on a desired number of degrees of rotation associated with release handle 112 releasing latch assembly 111. For example, increasing a distance d1 between an attachment point 160 of cable 128 to first latch pin 118a and an interference point 162 between cable 128 and cable retainer 130 increases the number of degrees release handle 112 will rotate before first and second latch pins 118a, 118b begin to translate out first and second orifices 126a, 126b. Stated differently, decreasing the distance d1 between attachment point 160 and interference point 162 decreases the number of degrees release handle 112 will rotate before first and second latch pins 118a, 118b begin to translate out first and second orifices 126a, 126b. Stated yet another way, decreasing a distance d2 between axis of rotation R of release handle 112 and interference point 162 increases the number of degrees release handle 112 will rotate before first and second latch pins 118a, 118b begin to translate out first and second orifices 126a, 126b.

Distances d1 and d2 are measured along a plane parallel to interior wall 114 of door 110. In accordance with various embodiments, the attachment point of cable 128 to second latch pin 118b is coplanar with attachment point 160, such that the distance, as measured along a plane parallel to interior wall 114 of door 110, between interference point 162 and the attachment point of cable 128 to second latch pin 118b is equal to distance d1.

In various embodiments, cable retainer 130 may be positioned such that release handle 112 rotates at least 45° about axis of rotation R before tension in cable 128 causes first and second latch pins 118a, 118b to translate completely out of first and second orifices 126a, 126b. In various embodiments, cable retainer 130 may be positioned such that release handle 112 rotates at least 90° about axis of rotation R before tension in cable 128 causes first and second latch pins 118a, 118b to translate completely out of first and second orifices 126a, 126b.

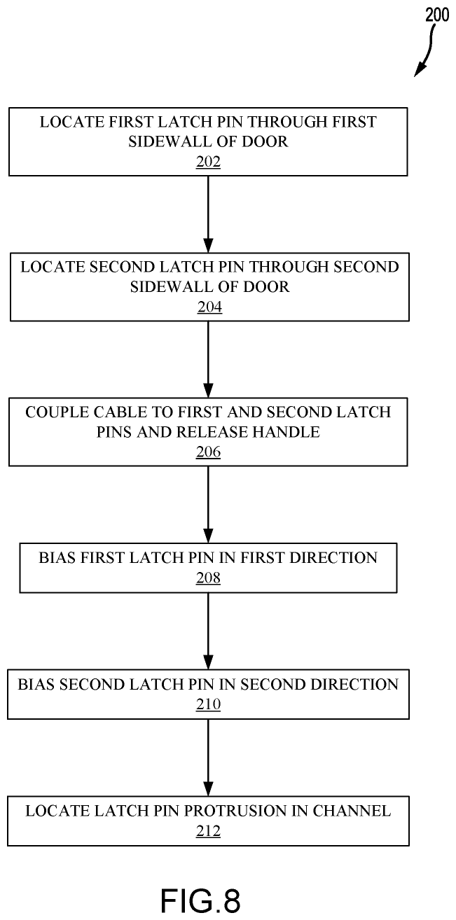

With reference to FIG. 8, a method 200 of assembling a latch assembly for securing a door for a storage compartment of a cabin attendant seat is illustrated. In accordance with various embodiments, method 200 may comprise locating a first latch pin through a first sidewall of the door (step 202), locating a second latch pin through a second sidewall of the door opposite the first sidewall (step 204), and coupling a cable to the first and second latch pins and to a release handle (step 206). The cable may be coupled to the first and second latch pins and the release handle such that rotation of the cable imparts tension in the cable and translates the first latch pin and the second latch pin linearly, in a direction parallel to an axis of rotation of the release handle.

In various embodiments, method 200 may further include biasing the first latch pin in a first direction (step 208) and biasing the second latch pin a second direction opposite the first direction (step 210). In various embodiments, step 208 may include biasing the first and second latch pins away from the release handle. In various embodiments, method 200 may further comprise locating a protrusion extending from the first latch pin in a channel defined by the door (step 212).

Benefits and other advantages have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, and any elements that may cause any benefit or advantage to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element is intended to invoke 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A latch assembly for a door of a cabin attendant seat storage compartment, latch assembly comprising:
a release handle configured to rotate relative to the door;
a cable coupled to the release handle; and
a first latch pin coupled to the cable, wherein the first latch pin is configured to translate in a direction parallel to an axis of rotation of the release handle.

2. The latch assembly of claim 1, further comprising a second latch pin coupled to the cable.

3. The latch assembly of claim 2, further comprising a cable retainer coupled to the release handle and configured to engage the cable.

4. The latch assembly of claim 3, further comprising:
a first biasing member operationally coupled to the first latch pin; and
a second biasing member operationally coupled to the second latch pin.

5. The latch assembly of claim 1, wherein the first latch pin comprises a head portion and a shaft portion.

6. The latch assembly of claim 5, wherein the head portion comprises a sloped surface.

7. The latch assembly of claim 6, wherein the cable is attached to the shaft portion of the first latch pin via a ball-and-socket joint.

8. A cabin attendant seat, comprising:
a housing;
a door rotationally coupled to the housing;
a release handle configured to rotate relative to the door;
a cable coupled to the release handle; and
a first latch pin coupled to the cable, wherein the first latch pin is configured to translate in a first direction parallel to an axis of rotation of the release handle.

9. The cabin attendant seat of claim 8, wherein a first wall of the housing defines a first orifice configured to receive the first latch pin.

10. The cabin attendant seat of claim 9, further comprising a second latch pin coupled to the cable, wherein a second wall of the housing defines a second orifice configured to receive the second latch pin.

11. The cabin attendant seat of claim 10, further comprising:
a first biasing member operationally coupled to the first latch pin; and
a second biasing member operationally coupled to the second latch pin.

12. The cabin attendant seat of claim 11, wherein the first biasing member is configured to bias the first latch pin toward the first wall of the housing, and wherein the second biasing member is configured to bias the second latch pin toward the second wall of the housing.

13. The cabin attendant seat of claim 12, further comprising a cable retainer coupled to the release handle and configured to engage the cable.

14. The cabin attendant seat of claim 8, wherein the first latch pin comprises a head portion and a shaft portion.

15. The cabin attendant seat of claim 14, wherein the head portion comprises a sloped surface, wherein the sloped surface is oriented away from an exterior wall of the door.

16. The cabin attendant seat of claim 15, wherein the cable is attached to the shaft portion of the first latch pin via a ball-and-socket joint.

17. The cabin attendant seat of claim 8, wherein the first latch pin comprises a protrusion located in a channel defined by the door.

18. A method of assembling a latch assembly for securing a door for a storage compartment of a cabin attendant seat, comprising:
locating a first latch pin through a first sidewall of the door;
locating a second latch pin through a second sidewall of the door opposite the first sidewall;
coupling a cable to the first latch pin and the second latch pin; and
coupling the cable to a release handle such that rotation of the cable imparts tension in the cable and translates the first latch pin and the second latch pin linearly along a plane parallel to an axis of rotation of the release handle.

19. The method of claim 18, further comprising:
biasing the first latch pin in a first direction; and
biasing the second latch pin a second direction opposite the first direction.

20. The method of claim 19, further comprising locating a protrusion extending from the first latch pin in a channel defined by the door.
